(19) United States
(12) Patent Application Publication
(10) Pub. No.: US 2007/0263923 A1
(43) Pub. Date: Nov. 15, 2007

(54) Method for Stereoscopic Measuring Image Points and Device for Carrying Out Said Method

(76) Inventors: Gennady Anatollevich Gienko, Novoslbirsk (RU); Vladimir Fedorovich Chekalin, Moscow (RU)

Correspondence Address: BELASCO, JACOBS & TOWNSLEY LLP;HOWARD HUGHES CENTER, 6100 CENTER DRIVE, SUITE 630, LOS ANGELES, CA, 90045, US

(21) Appl. No.: 10/599,969

(22) PCT Filed: Apr. 27, 2004
(86) PCT No.: PCT/RU04/00181

§ 371 Date: Jun. 28, 2007

(51) Int. Cl. G06K 9/00

(52) U.S. Cl. 382/154

(57) ABSTRACT

A method of measuring stereoscopic image points comprising the steps of: construction of a stereoscopic model of an object using a pair of overlapping images; determination of the aiming vectors of the eyes during stereoscopic perception of that model; recording aiming vector data at the moment of eye fixation, by computing a projection of the area of fixation of the observed model on a monitor screen, for each eye; and calculating a typical point of the object being observed. Also, device for the stereoscopic measuring of the position data of image points comprising: a left video-camera for tracking movements of an observer's left eye; a right video-camera for tracking movements of the observer's right eye; a video-camera for tracking the observer's head movements; a video-capture system for allowing capturing of an image by a personal computer; a monitor for displaying the image; and a stereo-observation system for allowing the observer to observe stereoscopic images.

### CROSS REFERENCE TO RELATED APPLICATION

this Application claims priority for International Application Number PCT/RU2004/00181, filed Apr. 27, 2004, and published as International Publication Number WO 2005/103616 A1 on Nov. 3, 2005.

### BACKGROUND OF THE INVENTION

(1) Field of the Invention

The invention relates to stereometry, particularly to non-contact methods of the determination of an object's spatial characteristics by its stereoscopic images. The invention and can be used in photogrammetry, medicine, construction, architecture, biology, systems of object identification, natural sources research, assessing risks of natural and man-made disasters and the effects thereof and for other similar purposes.

(2) Description of the Related Art

There is a known method of stereoscopic measuring of image points, which consists of stereoscopic measuring of a stereo-model by determining the position of the aiming axes of the eyes, relative to the main optical axis of the monitoring system. (SU No. 551504, G01C 11/04, 25.03.1977).

The weak points of said method are:

Absence of the visual control of the stereo-images monitoring process, and, therefore, low measuring productivity.

Low precision of determining the position of the aiming axis of eyes at the moment of eye focusing.

Eye fixation is determined by the physiological features of human vision; it is a transitional process of sight fixation at the time of focusing on any point of the subject during a period of time. The said method implies the detection of the moment of focus based on amplitude analysis and of position speed change of the aiming axes of eyes. But because the human eye continuously makes micro-movements, sight fixation is not a geometric point which is stable in time and space, but a zone of undetected shape, which is being formed in some range of time. Since the concrete points with discrete data are required for the photogrammetric construction, the use of fixation determined by the method described, does not allow detecting the position of the aiming axis of eyes with the precision required for photogrammetric measuring precision.

On the other hand, because of the individual lateral differences, the movements of the left and right eye are not synchronous. That is why the selected fixations do not determine the moment when both eyes look at the same point of the subject.

The principal scheme of the device (SU No. 551504, G01C 11/04.25/03/1977), which allows carrying out the stereoscopic method of measuring image points, is already known.

The described principal scheme of the device consists of a photogrammetric device of the analytic type, containing the processor inside; with a built-in system of image entry into a television and automates eye movements' electronic analyzers on the base of vidicons.

The device is assigned to measure photographic images using a prism-cube with a partly silver-plated internal edge for construction of the observer's eye image in a television automated vidicon ocular.

The weak points of the principal scheme of the described device are:

lack of the “feedback” system (i.e reflection of the measuring data on the images themselves), which leads to lack of observation control.

lack of precise compensation mechanism for head movement, because compensation offered for head movement is based on measuring of an eye reflection, which is formed by infrared sources of radiation and does not take into consideration the geometrically uneven shape of the eye, which causes nonlinearity of change of the glare position at the time of eye movement; besides, while the head position is changing at the time of focusing on the point of the image, the eye makes some compensating movements, which also leads to the nonlinear modification of the glare position.

Impossibility of the precise discrete fixation of the measuring data with the use of the systems, which are built on the base of the television with analog vidicons.

Low precision of the detection of the center of the pupil of the eye, which is caused by low contrast of the human eye images, if the light sources assigned only for highlighting images are used.

Losses of optical radiation at the time of passing through the prism-cube with the partially silver-plated internal edge.

Small range of vision of the optical systems, which are used in analog photogrammetric devices.

There is a device which can precisely detect the direction of sight. (A Precise Eye-Glaze Detection and Tracking System, A. Perez, M. L. Cordoba, A. Garcia, R. Mendez, M. L. Munoz, JL. Pedraza, F. Sanchez, WSCG'2003, February 3-7, 2003 Plzen, Czech Republic).

The described device consists of a surveillance camera for tracking eye movements, panoramic camera for tracking head movements, system for image entry into personal computer, and four infrared radiators for forming special glare-marks on the eye surface.

The weak points of the described device are lack of precise compensation of the head movements and necessity for use the video-cameras with a very high definition. Movements of the head are detected in the device from images of observer's face (in particular, by identification of the eyes on the entire face image), which is done by the wide-angle video-camera for tracking the head. Parts of the face have some relative movements, that is why they can not be used as the stable base points of the head, and that is why the method used in the device is not precise and, therefore, cannot comply with the requirements for high-precision measuring. The device presumes the use of only one video-camera to receive eye images, but eyes of the observer are located at some distance from each other. In addition to the images of the eyes there is insignificant information data, captured by the camera (that part of the face in the bridge of nose area). Therefore, in order to receive precise enough images, it is necessary to increase the requirements for the camera's definition capacity, i.e. to use a matrix of large dimension in the video-cameras. But increase of the matrix dimension leads to increase of the volume of the incoming video-information, which noticeably increases the requirements for the productivity and speedy action of the video-capture plate. The invention solves the problem of increasing the productivity of measuring the spatial characteristic of the object by its images on the stereoscopic pictures.

Development of a method and apparatus for non-contact stereometry which can determine the fixation points of the eyes with increased precision represents a great improvement in the field of stereometry and satisfies a long felt need of engineers.

### SUMMARY OF THE INVENTION

The present invention is a method of measuring stereoscopic image points comprising the steps of: construction of a stereoscopic model of an object using a pair of overlapping images; determination of the aiming vectors of the eyes during stereoscopic perception of that model; recording aiming vector data at the moment of eye fixation, by computing a projection of the area of fixation of the observed model on a monitor screen, for each eye; and calculating a typical point of the object being observed.

The typical point can be identified for the left and right eye by time synchronization. Additionally, the typical point can be calculated using a vectors coplanarity equation.

The method should be calibrating before starting observations by: observation of test-objects, with known position data in a main monitor; comparing positions of the centers of the pupils of the eyes with a camera; and selection of the mathematic dependencies, describing mutual transformations of the position data.

During calibration, test objects are presented for observation with different conditions, such as: time, duration, order of appearance, location, size, shape, color, background, static appearance and dynamic appearance.

During observation, visual control of measuring can be done on the monitor screen by imprinting color markers into an area of image, corresponding to the fixations.

Visual control of measuring can be done on the monitor screen by modifying the color parameters of the area of the observed image corresponding to the fixations.

Compensation for an observer's head movements can be calculated by comparing motion of the aiming vectors of both eyes with observations of movements of the observer's head. Alternatively, compensation for an observer's head movements can be calculated by tracking the movements of several marks fixed on the observer's head.

The observer's head movements can be tracked by marks fixed close to the observer's eyes and images of the marks captured by video-cameras tracking the observer's eyes movements. Parameters of head movement are preferably detected on two different planes. The marks are specially shaped, preferably ellipsoidal.

The position of the pupil of each eye movement can be determined in three-dimensional space by receiving two images of each eye by two synchronized video-cameras, fixed on opposite sides of a head.

The present invention is also a device for the stereoscopic measuring of the position data of image points comprising: a left video-camera for tracking movements of an observer's left eye; a right video-camera for tracking movements of the observer's right eye; a video-camera for tracking the observer's head movements; a video-capture system for allowing capturing of an image by a personal computer; a monitor for displaying the image; and a stereo-observation system for allowing the observer to observe stereoscopic images.

The stereo observation system can include a construction made in the shape of eyeglasses. Preferably, the eyeglasses include first specially shaped marks located in the vertical plane so that images of the first specially shaped marks are captured by the left and right video cameras. The special shape is preferably ellipsoidal.

The eyeglasses may also include second specially shaped marks which are located on the horizontal plane and a mirror fixed above the observer's head, whereby the video-camera is aimed so as to capture at the same time part of the observer's head and a reflection in the mirror of the second specially shaped marks. Again, the special shape is ellipsoidal.

The invention may further include: an additional right video camera installed to track movements of the right eye; and an additional left video camera installed to track movements of the left eye.

The invention may also include an additional monitor for visual control and operating the process of observation.

The invention may also include a system for infrared highlighting of the observer's eyes.

The invention may also include infrared color filters in front of the right and left video cameras.

The problem can be solved by the following: according to the invention in the method of stereoscopic measuring of image points including: construction of a stereoscopic model based on two overlapping images, detection of the position of the aiming axes of the eyes in stereoscopic perception of that model, and recording the observation results at eye fixation moments. The projection of the sight fixation area on the monitor screen of the observed images is computed and the typical points of the observed object, corresponding with those areas, on the fragments of digital stereo-images, are selected.

There are additional choices to carry out the method:

to identify typical points of the same name of the observed subject, which are selected on the fragments of the digital stereo-images, correlating with areas of sight fixation, for the left and right eye by time synchronization;

to identify typical points of the same name of the observed subject, which are selected on the fragments of the digital stereo-images, correlating with areas of the sight fixation, for the left and right eye, starting with the condition of crossing of the corresponding rays, determined by the vectors' coplanarity equation;

to do the calibration of the system before starting the observation, by observation of the image with test-objects with the known position data in the system of the position data of the main monitor, comparing the position data of the pupils of the eyes, determined in the system of position data of the video-camera, with the position data of the test objects, shown on the main monitor, and the subsequent mathematic dependencies, describing mutual transformations of position data.

at the time of system calibration, to position the test objects for observation in different conditions (for example, time, duration and order of appearance of the test objects, disposition, size, shape and color of the test objects, surrounding background, static or dynamic conditions of the test object appearance);

while observing, to visually control the measuring data on the screen of the main monitor by imprinting the color markers into the image area, coordinating with that fixation;

to do a visual control of measuring on the main monitor screen by modifying the color parameters of the area on the stereo-image, corresponding with that fixation;

to do compensation of the observer's head movements by computing the movement in the position of the aiming axes of the eyes with images of certain parts of the observer's head.

to do compensation of the head movement of the observer by tracking several marks, fixed on the head of the observer;

to track the head movement by the marks fixed close to the eyes in a way to get the images of those marks captured by the video-cameras, which record the observer's eyes movements;

to make the marks for tracking the observer's eye movements in a special (for example, ellipsoid) shape, which allows detecting precisely the position and orientation of the mark, and, accordingly, movements of the observer's head;

to detect the position data of the motion of the head in two mutually perpendicular planes;

to detect the pupil of the eye position while recording the movements of the eyes in three-dimensional space by receiving two images of each eye by two synchronized video-cameras, fixed on different sides of the head.

The problem can be solved by additional input, according to the invention. The construction is made in the shape of an eyeglasses frame with specially shaped marks, positioned on the vertical plane, which is incorporated into the device stereoscopic measuring image points. It consists of two video-cameras for recording movements, a video-cameras for tracking head movements, a system for video-capture of the image by a personal computer, a monitor for displaying the image, and a system of stereo-surveillance, which allowing observation of stereoscopic images, so that eye movements are recorded by cameras

Additional versions of the device are possible:

to install the additional specifically shaped marks, located on the horizontal plane, into the eyeglasses frame and to install a mirror, placed above the observer's head, into the device with a video-camera for capturing at the same time part of the head and the reflection in the eyeglasses frame mirror with the specially shaped marks placed on the horizontal plane on it;

to install in the system, in addition to the main two video-cameras for tracking the movements of each eye separately, two additional video-cameras, placed in a way to synchronically record the movements of each eye by the main and the additional video-cameras from two points;

to install an additional monitor for visual tracking the observation and operation of the observation process;

to install system for infrared highlighting of the area around the eyes;

to install infrared color filters on the cameras to cut off the parasite highlighting in the visible range of the spectrum.

An appreciation of the other aims and objectives of the present invention and an understanding of it may be achieved by referring to the accompanying drawings and description of a preferred embodiment.

### BRIEF DESCRIPTION OF THE DRAWINGS

FIG. 1—typical trajectories of the eye at the time of sight fixation while focusing on the point of the object;

FIG. 2—scheme of the stereoscopic observation of the stereo images on the monitor screen;

FIG. 3 and FIG. 4—general view of the device for measuring the three-dimensional position data based on its stereo-images;

FIG. 5—eyeglasses frame with the specifically shaped marks (for example, ellipsoidal shape), for the recording of the head movements;

FIG. 6—scheme of locations of the main and additional video-cameras for the recording of the eye movement in three-dimensional space.

### DETAILED DESCRIPTION OF THE PREFERRED EMBODIMENT

While the present invention is described herein with reference to illustrative embodiments for particular applications, it should be understood that the invention is not limited thereto. Those having ordinary skill in the art and access to the teachings provided herein will recognize additional modifications, applications, and embodiments within the scope thereof and additional fields in which the present invention would be of significant utility.

Construction of the three-dimensional model of the object in the real time while focusing on it's visual copy on two flat stereo-images can be done by tracking micro-movements of the observer's eyes and recording the sight fixations; with the subsequent computing the multitude of the points of intersection of the corresponding (paired) rays, and determining the homorganic virtual surface which is identical to the geometric surface of the object.

The determination of sight fixations can be done by dividing the basic consecution of the eye movement contents into areas of fast movement (saccades) and areas of the sight stabilization (fixations) separately for each eye. On FIG. 1, the typical trajectories of the eye are pictured at the time of sight stabilization while focusing on the point of the object. Areas of fixations 1 are marked with dotted lines. As a rule, detection of the point of fixation 2 (—highlighted by the solid line) can be done by computing the simple geometric average or the average weighted centroid of the points of the sight trajectory in the limits of the fixation area 1. However, as is shown on FIG. 1, for that, the problem of vagueness of choice of the concrete points of fixation 2 occurs, which is caused by significant dispersion of the points of trajectory of eye movement in the limits of fixation area 1.

It is suggested to solve that vagueness in the following way. Because the purpose of the stereoscopic measuring is to determine the spatial characteristics of the object, the observer focuses on the typical points of the object, making the object different from the environment and determining its shape and size. It is natural to assume, that the projection of the sight fixation area 1 on the observed image on a monitor screen contains one or several of those points. Position data of those points on the digital image can be found automatically, applying the Harris algorithms, KLT or similar.

In practice, the algorithms described can select several typical points on the image fragment, corresponding with that fixation area 1. Because a human being, physiologically, can-not stabilize his/her sight on two different points of an object, it is suggested to synchronize by time the fixation points 2, selected in the fixation areas 1 of the left and right eye with the use of algorithms for searching the typical points on the image. Time synchronization allows reduction in ambiguity of detection of the typical points on the image in the limits of the fixation area, corresponding to the focusing on the object by two eyes at the same time. However, because of the lateral asymmetries of each individual (dynamic asymmetry of one of the eyes, i.e. some “delay_gap”, which is similar to the “right-hander, left-hander” effect), that direction still can-not comply with the actual state of the corresponding rays, pre-existing at the time of focusing on the concrete point of the object.

That ambiguity is solved by the analysis of the geometric intersection of the aiming rays of the left and right eye at the time of stereoscopic focusing on the point of the object.

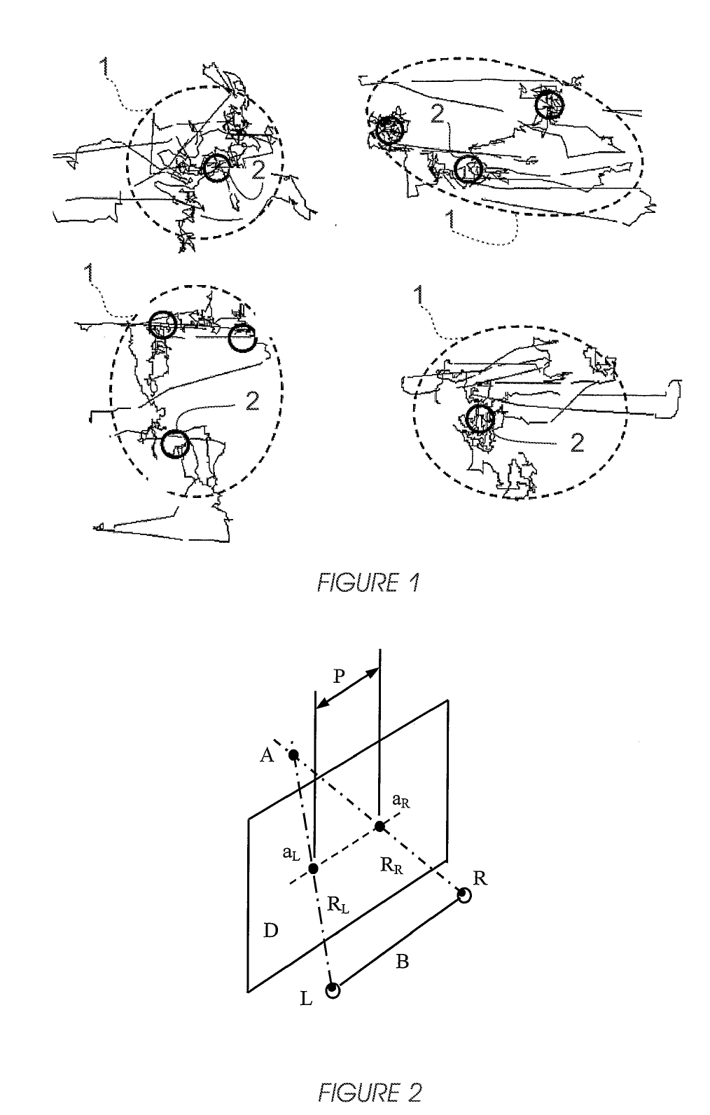

The characteristics of the human binocular vision are such that horizontal spatial parallax P between the pair of the corresponding points a_{L} and a_{R} on two images, located on the same plane (—with the condition of their separate observation by the eyes, FIG. 2) causes in human beings the sensation of perception of the certain point, located out of the plane. As it is shown on the FIG. 2, the plane D is a display-plane with the stereo-images, on which the observer's eyes are focusing, and axis R_{L}-R_{R} is the vision axis which corresponds to the left L and right R eye. B is the eye base. While focusing separately on two corresponding points a_{L} and a_{R} reflected on the left and right image of the stereo-pair, the image of the point A of the object's virtual model, formed as a result of intersection of the sight axis R_{L}-R_{R}, is formed in the human brain. This point is the geometric intersection of the corresponding rays belonging of the vectors R_{L} and R_{R} in the same plane, passing through the eye base B. That condition is written by the vector coplanarity equation: B(R_{L}×R_{R})=0

Therefore, in the method suggested, the candidate points 2, selected in the limits of the corresponding fixation areas 1 for the left L and right R eyes, first have to be synchronized, and then have to be checked for compliance with the condition of vector coplanarity. That the corresponding vectors R_{L}-R_{R} are in the same primary plane is a strict geometric condition for observation of the specific point on the stereo-image. Therefore, the multitude of the points of intersection of the corresponding (conjugate) rays, satisfying the condition of the coplanarity, while focusing on the stereo model, determines the homorganic virtual surface, which is identical to the geometric surface of the observed object.

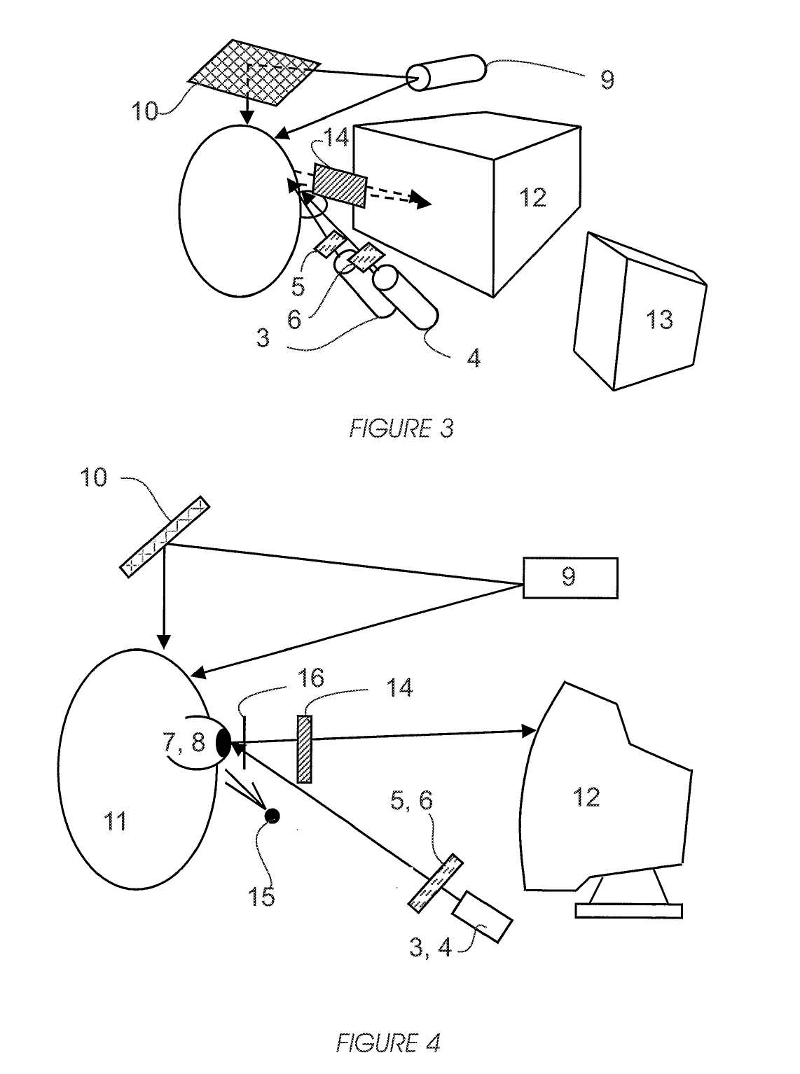

To carry-out the suggested method of stereoscopic measuring image points, the device (FIG. 3 and FIG. 4) is offered, containing video-cameras 3 and 4 with infrared color filters 5 and 6 for recording —the eyes' 7 and 8 movements. Accordingly, the video-camera 9 and the mirror 10 track the head 11 movements. A system of video-capture captures the image on a personal computer. The Main Monitor 12 shows the stereo-image under review. The additional (controlling) monitor 13 visually controls the process of observation and operates the observation process, system of stereo-surveillance 14, system of infrared eyes highlighting 15 and eyeglasses frame 16 with the specially shaped marks 17 and 18.

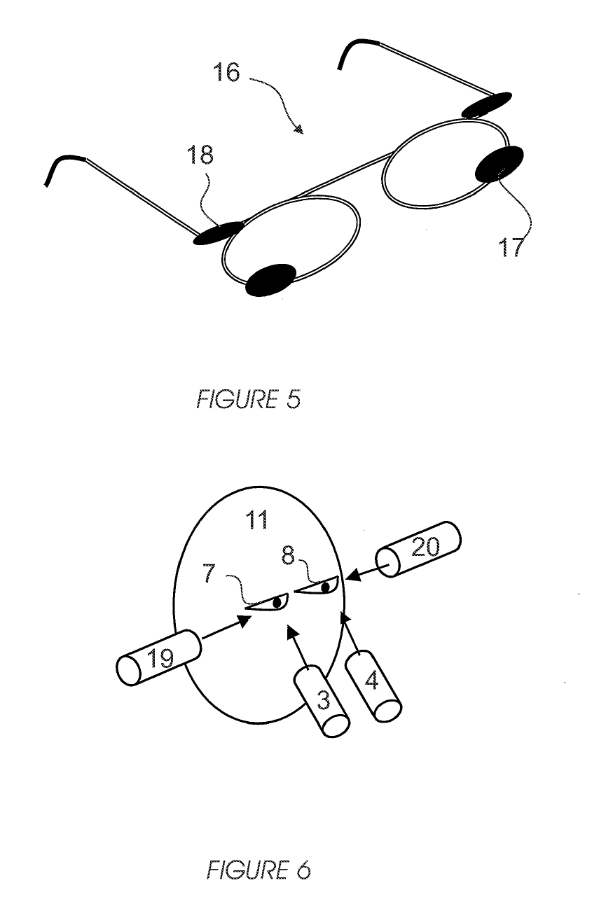

FIG. 5 represents the eyeglasses frame 16 with the specifically shaped marks 17 and 18, for example, in ellipsoidal shape. The marks 17 are located in the vertical plane so that their images can be captured by the corresponding cameras 3 and 4, recording the eyes' 7 and 8 movements. The special marks 18 are located on the horizontal plane so that their image is captured through the mirror 10 by the video-camera 9. The images 17 and 18 are used for tracking the head 11 movements.

The scheme of the location of the main 3 and 4, and the additional video-cameras 19 and 20 for tracking the eyes' 7 and 8 movements in the three-dimensional space is represented on FIG. 6.

The device for measuring the spatial characteristic of the object by its stereo-images works the following way.

For observation of the object based on its stereo-images, the stereoscopic images are displayed on the screen of the main monitor 12. Calibration of the system has to be done for each different observer. For calibration, the observer observes static and dynamic test objects, displayed on that monitor 12. The main idea of calibration is to determine the dependencies between the position data of the centers of the pupils of the eyes 7, 8, captured by the video-cameras 3 and 4 at the moments of sight stabilization during the observation of the test objects on the monitor screen 12, and the position data of those objects with the subsequent consideration of the psycho-physical particularities of the specific observer at the time of observation and analysis of those results. The calibration can be done either in monocular regime (both eyes focusing on a mono-image of the test objects on the monitor screen), or in stereoscopic regime (focusing on the virtual models of the three-dimensional test objects, using the stereo-viewing system).

Observations are performed by focusing on the stereoscopic images of the observed object with the fixation of the sight trajectory with the consideration of the calibration results, detection of the fixation areas and points with the control by the condition of coplanarity and the following determination of the spatial position data of the object. The determination of the spatial position data of the points of the object surface can be done by the analysis of the lengthwise Parallax P by the use of the set of two-dimensional position data of the corresponding points in the fixation areas 1 on the base of transformations, which are used in photogrammetry or projective stereometry. The construction of a three-dimensional model is done by orientation of the virtual model constructed, relative to the set of the fixed basic points, assigning the external system of position data of the object.

Compensation of head movements is realizaedaccomplished by determination of the movements factors by the computed movements of the image by use of the special marks 17 and 18 and entry of the corresponding compensating amendments in the position data of the pupil of the eye. The camera, tracking the head movements, must be synchronized with the video-cameras 3,4, tracking the eyes' movements.

The use of the additional video-cameras 19 and 20 for tracking the eyes' micro-movements allows determination of the three-dimensional position of the pupil of the eye and to increase the precision of the sight direction computing.

Control of the observations is realized by feedback communication, when the fixation areas 1 with the correctly calculated location of the point of intersection of the corresponding rays are marked on the screen of the controlling-monitor 13 by imprinting the color markers, and on the screen of the main Monitor 12 by changing the color parameters of the part of the image, corresponding with that fixation. The feedback makes it possible for the observer not only to control the progress of work (i.e. to see the areas of the image, in which the review is already done), but to estimate the quality of the observation as well, analyzing the color of the markers, imprinted into the image on the controlling monitor 13. The color of the markers is determined by the values of divergence of the residual vertical parallaxes, calculated with the condition of coplanarity and corresponding with the certain points of fixation 2. Because the mechanism of feedback shows the areas, where the observations have been already done, the control results also can be used at the time of recommencement of work after interruption.

The claimed method and the device of stereoscopic measuring image points can be utilized industrially in computer systems, used for digital stereoscopic measuring as well as in the fields like digital interaction photometry, image detection, three-dimensional measuring in medicine, biology, natural sources research, mine workings, natural sources workings, assessing risks of natural and man made disasters and the effects thereof, interactive teaching systems, systems for stereo-vision tests, system of professional aptitude tests, computer and television games. The industrial adaptability of the invention has been proved by the tests of the sample of the device, carrying out the claimed method.

The following reference numerals are used in FIGS. 1 through 6:
1 area of fixation
2 point of fixation
3 left video camera
4 right video camera
5 left infra red filter
6 right infra red filter
7 right eye
8 left eye
9 head movement tracking video camera
10 head movement tracking mirror
11 head
12 main monitor
13 control monitor
14 stereo-surveillance system
15 infra red light
16 eyeglasses
17 vertical marker
18 horizontal marker
19 right additional video camera
20 left additional video camera
P parallax
a_{L} left corresponding point
a_{R} right corresponding point
D display plane
R_{L}_l -R_{R} vision axis
L left eye
R right eye
B eye base
object virtual model

Thus, the present invention has been described herein with reference to a particular embodiment for a particular application. Those having ordinary skill in the art and access to the present teachings will recognize additional modifications, applications and embodiments within the scope thereof.

It is therefore intended by the appended claims to cover any and all such applications, modifications and embodiments within the scope of the present invention.

1.-19. (canceled)

20. A method of measuring stereoscopic image points comprising the steps of:
a. construction of a stereoscopic model of an object using a pair of overlapping images;
b. determination of the aiming vectors of the eyes during stereoscopic perception of that model;
c. recording aiming vector data at the moment of eye fixation, by computing a projection of the area of fixation of the observed model on a monitor screen, for each eye; and
d. calculating a typical point of the object being observed

21. The method as claimed in claim 20 in which said typical point is identified for the left and right eye by time synchronization.

22. The method as claimed in claim 20 or 21 in which said typical point is calculated using a vectors coplanarity equation.

23. The method as claimed in claim 20 or 21 further comprising the step of calibrating said method before starting observations by:
a. observing of test-objects, with known position data in a main monitor;
b. comparing positions of the centers of the pupils of the eyes with a camera; and
c. calculating the mathematic dependencies, describing mutual transformations of said position data.

24. The method as claimed in claim 22 further comprising the step of calibrating said method before starting observations by:
a. observing of test-objects, with known position data in a main monitor;
b. comparing positions of the centers of the pupils of the eyes with a camera; and
c. calculating the mathematic dependencies, describing mutual transformations of said position data.

25. The method as claimed in claim 23 further comprising the step of presenting said test objects for observation with a condition selected from the group consisting of time, duration, order of appearance, location, size, shape, color, background, static appearance and dynamic appearance.

26. The method as claimed in claim 24 further comprising the step of presenting said test objects for observation with a condition selected from the group consisting of time, duration, order of appearance, location, size, shape, color, background, static appearance and dynamic appearance.

27. The method as claimed in claims 20 or 21 further comprising the step of visually controlling of measuring on said monitor screen by imprinting color markers into an area of image, corresponding to said fixations.

28. The method as claimed in claim 22 further comprising the step of visually controlling of measuring on said monitor screen by imprinting color markers into an area of image, corresponding to said fixations.

29. The method as claimed in claim 20 or 21 further comprising the step of visually controlling of measuring on said monitor screen by modifying the color parameters of the area of the observed image corresponding to said fixations.

30. The method as claimed in claim 22 further comprising the step of visually controlling of measuring on said monitor screen by modifying the color parameters of the area of the observed image corresponding to said fixations.

31. The method as claimed in claim 20 or 21 further comprising the step of compensating for an observer's head movements by comparing motion of the aiming vectors of both eyes with observations of movements of said observer's head.

32. The method as claimed in claim 22 further comprising the step of compensating for an observer's head movements by comparing motion of the aiming vectors of both eyes with observations of movements of said observer's head.

33. The method as claimed in claim 20 or 21 further comprising the step of compensating for an observer's head movements by tracking movements of several marks fixed on said observer's head.

34. The method of claim 22 further comprising the step of compensating for an observer's head movements by tracking movements of several marks fixed on said observer's head.

35. The method as claimed in claims 20 or 21 further comprising the steps of:
a. tracking an observer's head movements by marks fixed close to said observer's eyes and
b. capturing images of said marks by video-cameras tracking said observer's eyes movements.

36. The method of claim 22 further comprising the steps of:
a. tracking an observer's head movements by marks fixed close to said observer's eyes and
b. capturing images of said marks by video-cameras tracking said observer's eyes movements.

37. The method as claimed in claim 35 in which said marks are specially shaped.

38. The method as claimed in claim 36 in which said marks are specially shaped.

39. The method as claimed in claim 35 in which said head movement are tracked in two different planes.

40. The method as claimed in claim 36 in which said head movements are tracked in two different planes.

41. The method as claimed in claims 20 or 21 further comprising the step of determining the position of the pupil of each eye during eye movement in three-dimensional space by receiving two images of each eye from two synchronized video-cameras, fixed on opposite sides of a head.

42. The method of claim 22 further comprising the step of determining the position of the pupil of each eye during eye movement in three-dimensional space by receiving two images of each eye from two synchronized video-cameras, fixed on opposite sides of a head.

43. A device for the stereoscopic measuring of the position data of image points comprising:
a. a left video-camera for tracking movements of an observer's left eye;
b. a right video-camera for tracking movements of said observer's right eye;
c. a video-camera for tracking said observer's head movements;
d. a video-capture system for allowing capturing of an image by a personal computer;
e. a monitor for displaying said image; and
f. a stereo-observation system for allowing said observer to observe stereoscopic images.

44. The device as claimed in claim 43 in which said stereo observation system includes a construction made in a shape of eyeglasses.

45. The device as claimed in claim 44 in which said eyeglasses include first specially shaped marks located in the vertical plane so that images of said first specially shaped marks are captured by said left and right video cameras.

46. The device as claimed in claim 45 in which said special shape is ellipsoidal.

47. The device as claimed in claim 45 further comprising:
a. second specially shaped marks which are located on the horizontal plane of said eyeglasses; and
b. a mirror fixed above said observer's head;
whereby said video-camera is aimed so as to capture at the same time part of said observer's head and a reflection in said mirror of said second specially shaped marks.

48. The device as claimed in claim 47 in which said special shape is ellipsoidal.

49. The device as claimed in any of claims 43-48 further comprising:
a an additional right video camera installed to track movements of said right eye; and
b. an additional left video camera installed to track movements of said left eye.

50. The device as claimed in any of claims 43-48 further comprising an additional monitor for visual controlling and operating the process of observation.

51. The device as claimed in any of claims 43-49 further comprising a system for infrared highlighting of said observer's eyes.

52. The device as claimed in any of claims 43-48 further comprising infrared color filters in front of said right and left video cameras.
